(19) United States
(12) Patent Application Publication
(10) Pub. No.: US 2026/0009274 A1
(43) Pub. Date: Jan. 8, 2026

(54) GATE TRANSMISSION PROTECTION DEVICE

(71) Applicant: Cubic Transportation Systems, Inc., San Diego, CA (US)

(72) Inventors: Mark Barry Pottinger, Lewes (GB); Christian Cabugon, Crawley (GB)

(73) Assignee: Cubic Transportation Systems, Inc., San Diego, CA (US)

(21) Appl. No.: 19/257,356

(22) Filed: Jul. 1, 2025

Related U.S. Application Data
(60) Provisional application No. 63/667,414, filed on Jul. 3, 2024.

(51) Int. Cl. E05F 15/614

(52) U.S. Cl. CPC E05F 15/614; E05Y 2201/216; E05Y 2900/40

(57) ABSTRACT

A transmission system with a protection device to enable damage control at a fare gate. The transmission system includes a motor, a gate paddle, and the protection device. The motor rotates a paddle shaft to drive the gate paddle. The gate paddle is operable to allow transmission through the fare gate. The protection device provides mechanical protection in case of an abusive load applied at the fare gate. The protection device includes a conical clutch that limits torque transmission at the fare gate. The conical clutch slips when torque applied to the paddle shaft reaches a preset threshold, disconnects the motor from a power supply, and stops rotation of the paddle shaft of the gate paddle.

### PRIORITY

This application is a non-provisional of and claims priority to U.S. Provisional Patent Application No. 63/667,414, filed Jul. 3, 2024, the contents of which is incorporated herein by reference in its entirety.

### BACKGROUND

This disclosure relates, in general, to a transmission system and, not by way of limitation, to damage control at the transmission system, among other things.

Fare gates are used to regulate entry and exit of a transit system, like a metro, subway, or train station. Fare evasion is a vexing problem that poses security threats and affects the transit system's revenue. The fare gate is operable to allow valid access efficiently, especially during peak volumes. Commuters passing through the fare gates may be accompanied by strollers, luggage, free-riding children, or various other objects. Mechanical paddles are actuated for valid commuters passing through the fare gates, with allowed objects or children.

Over time, constant use by thousands of commuters leads to mechanical degradation, causing fare gates to malfunction or operate less smoothly. This can result in longer queues, delays, and frustration among passengers. Additionally, frequent repairs and maintenance increase operational costs for transit authorities. In severe cases, compromised fare gates can lead to security vulnerabilities, allowing unauthorized access and fare evasion.

### SUMMARY

In one embodiment, the present disclosure provides a transmission system with a protection device to enable damage control at a fare gate. The transmission system includes a motor, a gate paddle, and the protection device. The motor rotates a paddle shaft to drive the gate paddle. The gate paddle is configured to allow transmission through the fare gate. The protection device provides mechanical protection in case of an abusive load applied at the fare gate. The protection device includes a conical clutch that limits torque transmission at the fare gate. The conical clutch slips when torque applied to the paddle shaft reaches a preset threshold, disconnects the motor from a power supply, and stops rotation of the paddle shaft of the gate paddle.

In an embodiment, a transmission system with a protection device to enable damage control at a fare gate. The transmission system includes a motor, a gate paddle, and the protection device. The motor rotates a paddle shaft to drive the gate paddle. The gate paddle is configured to allow transmission through the fare gate. The protection device provides mechanical protection in case of an abusive load applied at the fare gate. The protection device includes a conical clutch that limits torque transmission at the fare gate. The conical clutch slips when torque applied to the paddle shaft reaches a preset threshold, disconnects the motor from a power supply, and stops rotation of the paddle shaft of the gate paddle. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. The protection device is activated when applied torque at the paddle shaft reaches the preset threshold. The preset threshold is based on the amount of force applied on the gate paddles. The conical clutch is mounted between the paddle shaft and a spur gear to limit torque transmission and the function of the conical clutch is independent of position of the spur gear.

In another embodiment, a transmission method with a protection device to enable damage control at a fare gate. In one step, the transmission method includes rotating a paddle shaft to drive a gate paddle via a motor. The gate paddle is configured to allow transmission through the fare gate. The protection device provides mechanical protection in case of an abusive load applied at the fare gate. The protection device includes a conical clutch that involves limiting torque transmission at the fare gate. The conical clutch further includes slipping when torque applied to the paddle shaft reaches a preset threshold, disconnecting the motor from a power supply, and stopping rotation of the paddle shaft of the gate paddle. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. The protection device is activated when applied torque at the paddle shaft reaches the preset threshold. The preset threshold is based on the amount of force applied on the gate paddles. The conical clutch is mounted between the paddle shaft and a spur gear to limit torque transmission and the function of the conical clutch is independent of position of the spur gear.

In yet another embodiment, a transmission device with a protection mechanism to enable damage control at a fare gate. The transmission device includes a motor, a gate paddle, and the protection device. The motor rotates a paddle shaft to drive the gate paddle. The gate paddle is configured to allow transmission through the fare gate. The protection mechanism provides mechanical protection in case of an abusive load applied at the fare gate. The protection mechanism includes a conical clutch that limits torque transmission at the fare gate. The conical clutch slips when torque applied to the paddle shaft reaches a preset threshold, disconnects the motor from a power supply, and stops rotation of the paddle shaft of the gate paddle. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. The protection mechanism is activated when applied torque at the paddle shaft reaches the preset threshold. The preset threshold is based on the amount of force applied on the gate paddles. The conical clutch is mounted between the paddle shaft and a spur gear to limit torque transmission and the function of the conical clutch is independent of position of the spur gear.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A-B illustrates a transmission system with a protection device to enable damage control at a fare gate;

FIG. 2 illustrates a planar view of the mechanical components involved in the rotation of the gate paddles of the fare gate;

FIG. 3 illustrates an assembly of a conical clutch as the protection device;

FIG. 4A illustrates an isometric view of the protection device integrated at the fare gate;

FIG. 4B illustrates a longitudinal sectional view of the protection device integrated at the fare gate; and

FIG. 5 illustrates a flow diagram of a transmission method with a protection device to enable damage control at a fare gate according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

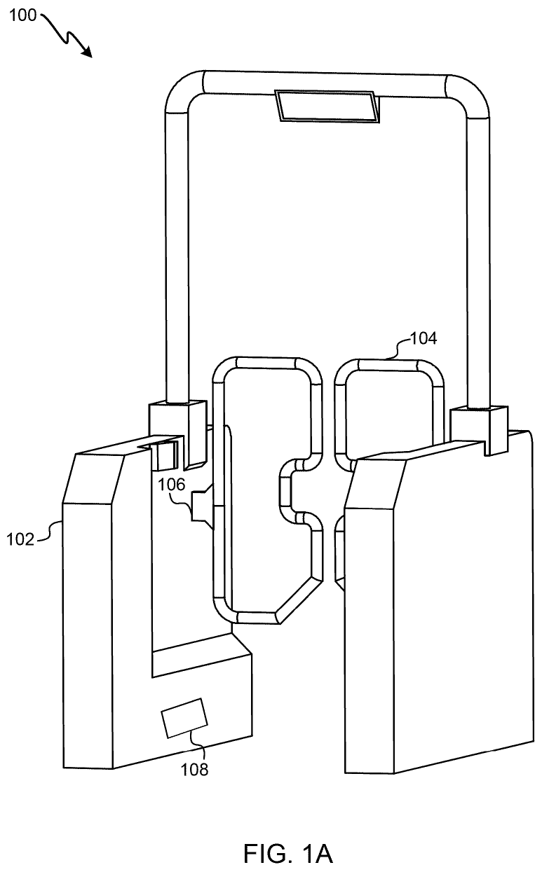

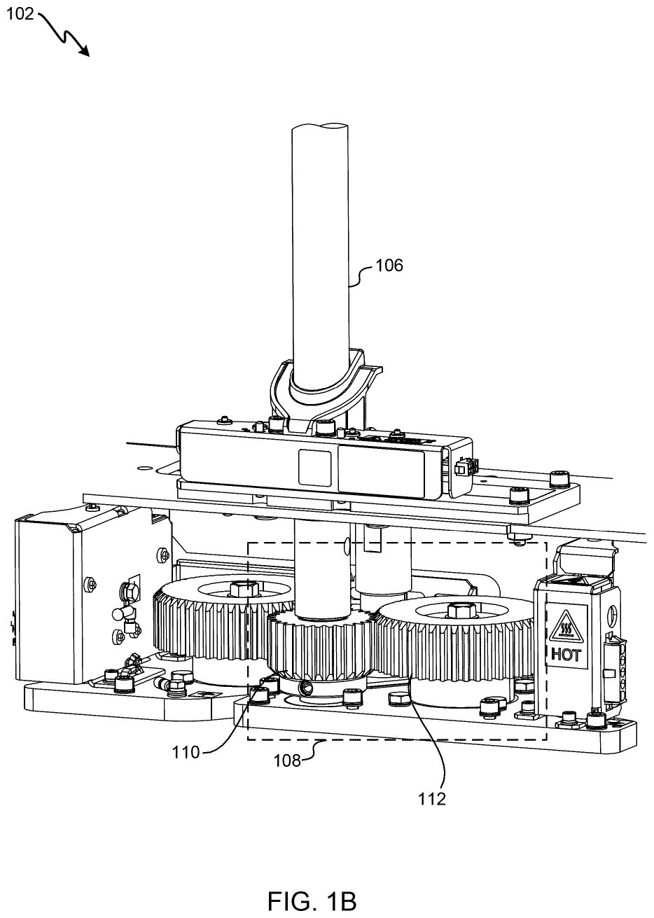

Referring to FIGS. 1A-B, a transmission system 100 with a protection device 108 to enable damage control at a fare gate 102 is shown as an embodiment. The transmission system 100 includes the fare gate 102 which is a foundational component of transportation systems. The fare gate 102 manages and controls passenger access to transit areas, such as subway stations, bus terminals, and train platforms. The fare gate 102 monitors if passengers have paid the fare before entering or exiting the transmission system 100, thereby helping to maintain revenue integrity and streamline passenger flow.

The fare gate 102 consists of gate paddles 104, paddle shaft 106, and the protection device 108 that work together to allow passage through the transmission system 100. The gate paddle 104 is the physical gate that opens and closes to allow or restrict access. The gate paddle 104 can be in the form of one or more sliding doors, rotating turnstiles, or flaps. The gate paddle 104 is connected to the paddle shaft 106 to allow transmission at the fare gate 102 based on rotation of the paddle shaft 106. Transmission through the fare gate 102 is granted when the gate paddle 104 is rotating, and transmission through the fare gate 102 is blocked when the rotation of the gate paddle 104 is stopped.

The fare gate 102 further validates fare payments and controls access. When a passenger approaches a fare gate, the passenger typically presents a ticket, smart card, or mobile payment to a reader integrated into the fare gate 102. The transmission system 100 then verifies the payment and, if valid, allows the fare gate 102 to open, granting access. This process helps prevent fare evasion, ensuring that passengers who paid the fare can use the transit services. By controlling entry and exit points, the fare gate 102 helps manage crowd flow, reduce congestion, and improve overall safety within transit stations.

In one embodiment, an E2 wide aisle gate (WAG) is designed with a longer paddle to accommodate wider aisles, providing easier access for passengers, including those with disabilities or carrying luggage. The transmission system 100 converts the torque from the paddle shaft 106 into the motion needed to open and close the fare gate 102. This longer paddle of the WAG increases the torque applied at the paddle shaft 106 during operation. Under normal conditions, the increased torque does not pose any issues, and the fare gate 102 functions smoothly, ensuring efficient and accessible entry and exit for passengers. However, when an excess load is applied at the fare gate 102, the increased torque can damage the internal components of the fare gate 102 over time.

The protection device 108 of the fare gate 102 is integrated where overloading could damage equipment and where the level of transmitted torque has to be limited. The protection device 108 provides mechanical protection for a shaft gear 110 and a motor gear 112 by disconnecting an electric motor from a power supply. Hence, stopping the rotation of the paddle shaft 106 and halting the passenger flow through the fare gate 102.

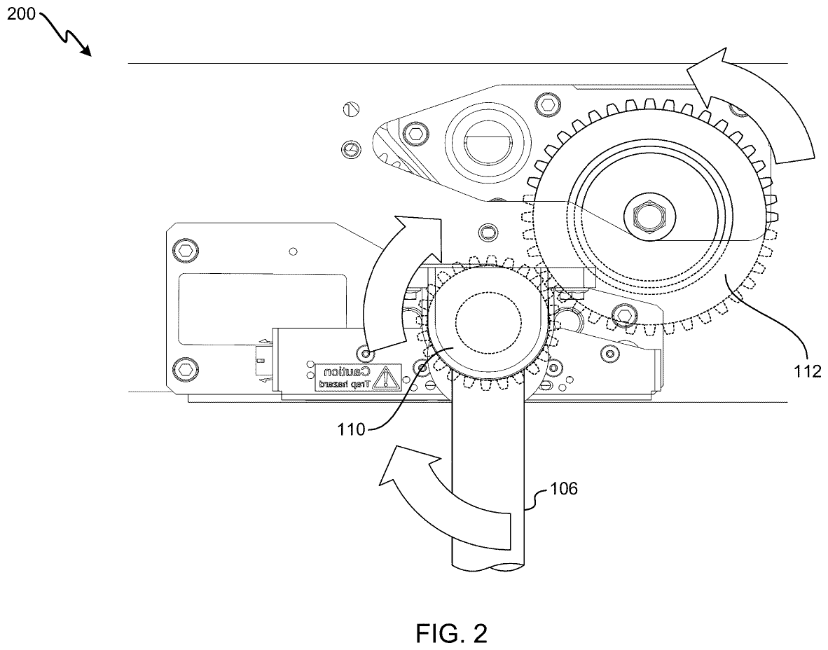

Referring next to FIG. 2, mechanical components 200 involved in the rotation of the gate paddles 104 of the fare gate 102 are shown as an embodiment. The motor gear 112, the shaft gear 110, and the paddle shaft 106 work together to control the movement of the gate paddles 104. The motor gear 112 is driven by the electric motor that serves as the primary source of motion for the transmission system 100. When the fare gate 102 is activated i.e., the power supply is connected, and the electric motor powers the motor gear 112, causing the motor gear 112 to rotate. This rotation is an initial step in the process of moving the gate paddle 104. The motor gear 112 provides the necessary torque to drive the subsequent components in the transmission system 100.

The shaft gear 110 is connected to the motor gear 112. The shaft gear 110 or the spur gear transmits a rotational motion from the motor gear 112 to the paddle shaft 106. The shaft gear 110 and the motor gear 112 are meshed, ensuring that the rotation of the motor gear 112 directly influences the rotation of the shaft gear 110. This connection is designed to be robust and precise, allowing for smooth and efficient transfer of motion. The shaft gear 110 is durable and capable of withstanding the forces exerted by the motor gear 112, especially during continuous operation in busy transit environments. The paddle shaft 106 is the component directly responsible for moving the gate paddle 104. The paddle shaft 106 is connected to the shaft gear 110, and as the shaft gear 110 rotates, the paddle shaft 106 rotates as well. The paddle shaft 106 converts the rotational motion into the movement of the gate paddle 104. This movement can be either opening or closing the gate, depending on the direction of rotation. The paddle shaft 106 is precisely aligned and securely attached to the gate paddle 104 to provide accurate and reliable operation.

The gate paddle 104 swings open or closed smoothly, providing a clear indication to passengers whether they can proceed or have to wait. The gate paddle 104 is designed to be durable enough to withstand the daily wear and tear of constant use, as well as any potential abusive loads that may be applied. The gate paddle 104 can become a point of vulnerability when subjected to abusive loads. An abusive load refers to excessive force or pressure applied to the gate, which can occur due to intentional misuse, accidental impact, or overcrowding. When such a load is applied to the extended WAG paddle, it can significantly stress the gate's transmission system.

One of the primary areas susceptible to damage is the shaft gear 110 or the adjacent spur gear. The shaft gears 110 are used to transfer motion and torque between shafts in the transmission system 100. When an abusive load is applied, the increased torque can cause the shaft gear 110 to wear out prematurely, become misaligned, or even break. This damage can disrupt the smooth operation of the fare gate 102, leading to mechanical failures and requiring costly repairs or replacements.

Additionally, the shafts and internal components of a gearbox are at risk of damage under abusive loads. The gearbox is a fundamental part of the transmission system 100, containing gears and shafts that work together to manage the torque and motion of the fare gate 102. Excessive force can cause the shafts to bend, break, or become misaligned, while internal components, such as bearings and gears, can suffer from increased wear and tear. This internal damage can compromise the overall functionality of the fare gate 102, leading to operational issues and potential safety hazards.

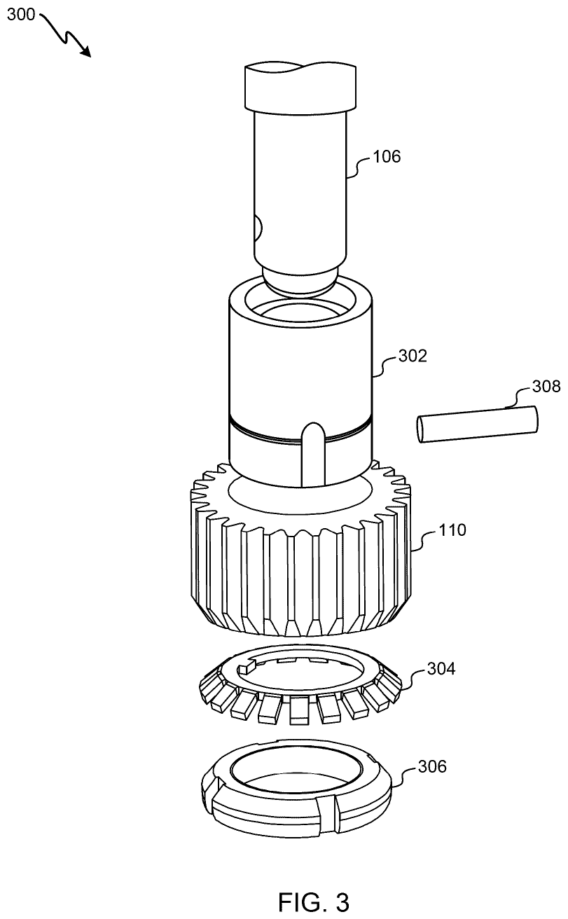

Referring next to FIG. 3, an assembly 300 of a conical clutch 308 as the protection device 108 is shown as an embodiment. The protection device 108 provides mechanical protection at the fare gate 102 when an abusive load is applied. The protection device 108 is activated when the applied torque at the paddle shaft 106 reaches a preset threshold. The paddle shaft 106 transmits torque from the motor to rotate the gate paddle 104. Under normal operation, the paddle shaft 106 rotates smoothly, allowing the gate paddle to 104 open and close as configured. A gear sleeve 302 houses and supports the gears, ensuring the gears rotate smoothly and remain aligned. The gear sleeve 302 reduces friction and prevents misalignment that could lead to operational issues.

The conical clutch 308 is the main component of the protection device 108. To limit torque transmission, the conical clutch 308 is mounted between the paddle shaft 106 and a spur gear (or the shaft gear 110). Furthermore, the function of the conical clutch 308 is independent of the position of the spur gear (or the shaft gear 110) and the conical clutch 308 limits torque transmission at the fare gate 102. The conical clutch 308 slips when torque applied to the paddle shaft 106 reaches a preset threshold. The preset threshold refers to an amount of torque that is allowed at the fare gate 102. The preset threshold is adjustable and is based on the amount of force applied to the gate paddles 104. This slipping action prevents excessive force from being transmitted, thereby protecting the transmission system 100 of the fare gate 102 from damage. The slipping of the conical clutch 308 disconnects the motor from the power supply, thereby stopping the rotation of the paddle shaft 106 and preventing further stress on the transmission system 100. Additionally, the conical clutch 308 can be mounted between any drive shaft and output gear, pulley, etc., where overloading could damage the equipment and where the level of transmitted torque needs to be limited.

The shaft gear 110 includes a motor output drive (MOD) connected to the shaft gear 110 that connects the MOD to the paddle shaft 106, facilitating the transfer of torque. Under normal conditions, the MOD to shaft gear ensures smooth transmission of rotational energy from the motor to the paddle shaft. However, when the abusive load is applied, the conical clutch 308 disengages this connection to prevent damage. A tab washer 304 and a lock ring 306 secure the components in place within the assembly 300. The tab washer 304 and the lock ring 306 keep the shaft gear 110 in place.

In one embodiment, a transmission device with a protection mechanism uses the conical clutch 308 that is built into an existing gate transmission system. The conical clutch 308 is used to transmit torque in a drive system. By disengaging the conical clutch 308, the primary source of motion is removed from the transmission device. An upper limit of torque that can be transmitted by the conical clutch 308 before the conical clutch 308 slips is adjustable and preset. Hence, the transmission device is protected from damage due to the abusive load.

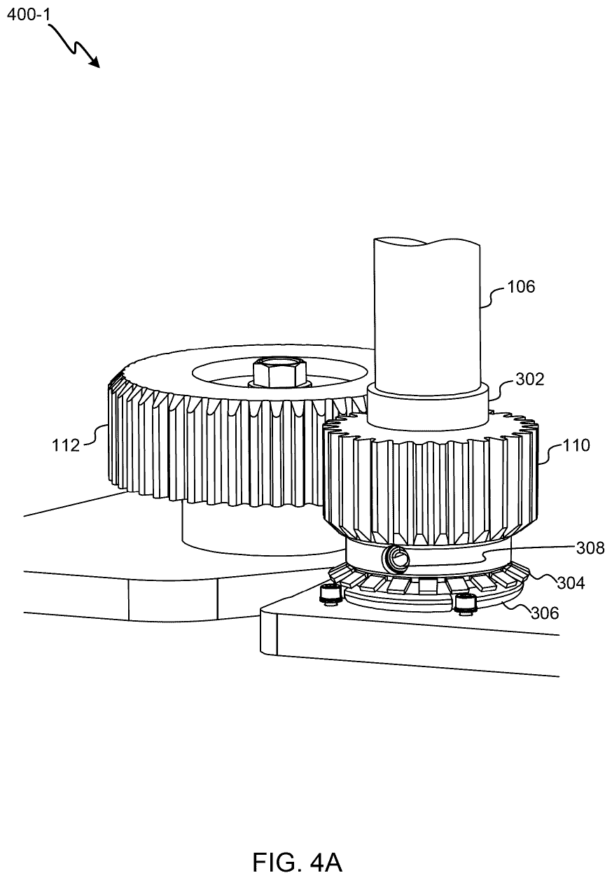

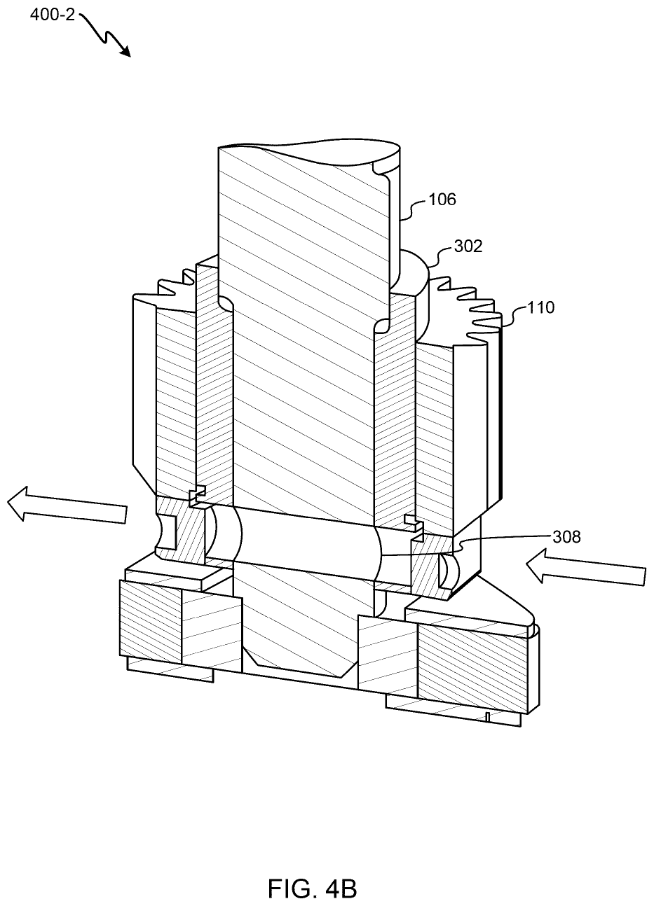

Referring next to FIG. 4A, a planar view 400-1 of the protection device 108 integrated at the fare gate 102 is shown as an embodiment. When an abusive load is applied to the fare gate 102, the conical clutch 308 of the protection device 108 provides mechanical protection at the transmission system 100. As the torque on the paddle shaft 106 reaches the preset threshold, the conical clutch 308 begins to slip. This slipping action limits the amount of torque transmitted to the paddle shaft 106, preventing excessive force from causing damage. By slipping, the conical clutch 308 effectively reduces the stress on the shaft gear 110 or the adjacent spur gear and other components within the transmission system 100.

In addition to limiting torque transmission, the conical clutch 308 disconnects the motor from the power supply. This disconnection stops the rotation of the paddle shaft 106, halting the movement of the gate paddle 104. By stopping the rotation, the conical clutch 308 prevents further stress and potential damage to the gearbox shafts and internal components. The coordinated interaction between the paddle shaft 106, gear sleeve 302, conical clutch 308, MOD to the shaft gear 110, and lock ring 306 ensures smooth operation while safeguarding against potential damage. Additionally, the lock ring 306 adjusts the preset threshold of torque, providing more torque in a clockwise rotation. The protection device 108 ensures that the fare gate 102 remains operational and safe, even under conditions of abusive load.

In one embodiment, the protection device 108 uses the conical clutch 308 configured into the existing gate transmission system without substantial redesign. The conical clutch 308 is adjusted to suit abuse conditions and uses the existing spur gear that can be modified for use. In other embodiments, the protection device 108 uses a magnetic particle clutch, a shaft protection device consisting of disc springs pre-loaded between plates, or a ball detent device.

Referring next to FIG. 4B, a longitudinal sectional view 400-2 of the protection device 108 integrated at the fare gate 102 is shown as an embodiment. The longitudinal sectional view 400-2 of the protection device 108 highlights the working mechanism of the conical clutch 308 when abusive load is applied at the gate paddles 104. When torque due to an abusive load applied at the gate paddles 104 of the fare gate 102 reaches the preset threshold, the conical clutch 308 slips or pops out in the direction of arrows, as shown in FIG. 4B. The preset threshold refers to an amount of torque that is allowed at the fare gate 102 and is based on the amount of force applied on the gate paddles 104. As the conical clutch 308 slips, the connection of the motor to the power supply is disconnected. As a result, the rotation of the paddle shaft 106 is stopped, and the gate paddles 104 stop working too. In this way, the mechanical protection provided by the protection device 108 prevents the internal components of the fare gate 102 from further damage. Managing torque transmission at the fare gate 102 increases longevity and efficiency of the transmission system 100.

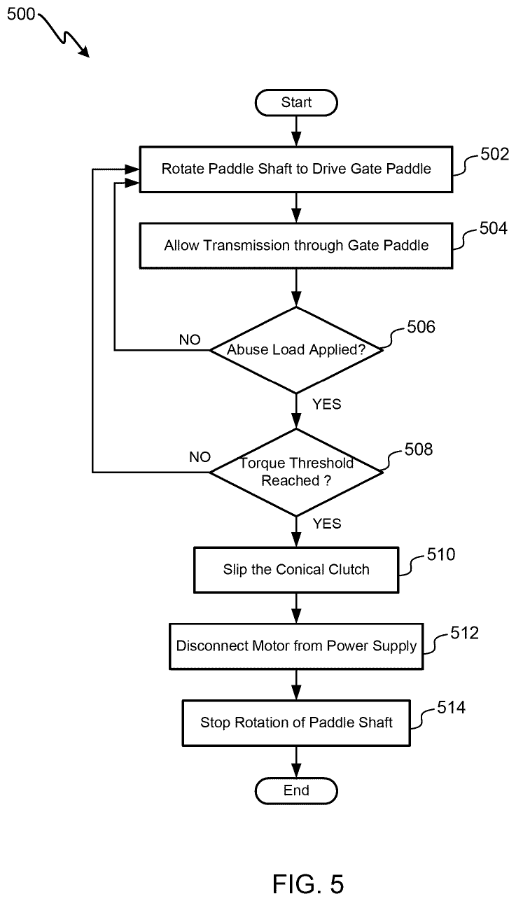

Referring next to FIG. 5, a transmission method 500 with the protection device 108 to enable damage control at the fare gate 102 is shown as an embodiment. At block 502, the transmission system 100 rotates the paddle shaft 106 to drive the gate paddles 104 of the fare gate 102. The gate paddle 104 is the physical gate that opens and closes to allow or restrict access. The gate paddle 104 can be in the form of one or more sliding doors, rotating turnstiles, or flaps.

At block 504, the gate paddles 104 are configured to allow transmission through the fare gate 102. Transmission through the fare gate 102 is granted when the gate paddle 104 is rotating, and transmission through the fare gate 102 is blocked when the rotation of the gate paddle 104 is stopped. At block 506, the transmission system 100 checks whether the abusive load is applied at the fare gate or not. The abusive load refers to excessive force or pressure applied to the fare gate 102, which can occur due to intentional misuse, accidental impact, or overcrowding. When such a load is applied to the extended WAG paddle, it can significantly stress the gate's transmission system. When an abusive load is applied at the fare gate 102, the increased torque can cause the shaft gear 110 to wear out prematurely, become misaligned, or even break. This damage can disrupt the smooth operation of the fare gate 102, leading to mechanical failures and requiring costly repairs or replacements.

If the abusive load is not applied, then the transmission system 100 keeps driving the gate paddles 104 at block 502. Otherwise, if the abusive load is applied, then the transmission system 100 checks whether the preset threshold for torque transmission to the motor has been reached or not at block 508. Managing torque transmission at the fare gate 102 increases longevity and efficiency of the transmission system 100.

If the preset threshold has not yet been reached, then transmission through the fare gate 102 is allowed at block 502. On the other hand, if the preset threshold for torque transmission has been reached, then the protection device 108 is activated and the conical clutch 308 slips at block 510. The protection device 108 ensures that the fare gate 102 remains operational and safe, even under conditions of abusive load. To limit torque transmission, the conical clutch 308 is mounted between the paddle shaft 106 and a spur gear (or the shaft gear 110). The conical clutch 308 is operable independent of position of a spur gear (or the shaft gear 110). The conical clutch 308 limits torque transmission by slipping when the torque applied to the paddle shaft 106 reaches a preset threshold. The preset threshold refers to an amount of torque that is allowed at the fare gate 102. The preset threshold is adjustable and is based on the amount of force applied to the gate paddles 104.

This slipping action disconnects the motor from the power supply at block 512. As a result, rotation of the motor gear 112 stops which leads to stopping the rotation of the paddle shaft 106 at block 514. In this way, the conical clutch 308 of the protection device 108 prevents excessive force from being transmitted, thereby protecting the fare gate 102 from damage. The slipping of the conical clutch 308 disconnects the motor from the power supply, stopping the rotation of the paddle shaft 106 and preventing further stress on the transmission system 100. Additionally, the conical clutch 308 can be mounted between any drive shaft and output gear, pulley, etc., where overloading could damage the equipment and where the level of transmitted torque has to be limited.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A transmission system with a protection device to enable damage control at a fare gate, the transmission system comprises:
a motor that rotates a paddle shaft to drive a gate paddle;
the gate paddle operable to allow transmission through the fare gate; and
the protection device to provide mechanical protection when an abusive load is applied at the fare gate, wherein the protection device comprises:
a conical clutch to limit torque transmission at the fare gate, wherein the conical clutch is operable to:
slip when torque applied to the paddle shaft reaches a preset threshold;
disconnect the motor from a power supply; and
stop rotation of the paddle shaft.

2. The transmission system with a protection device to enable damage control at a fare gate of claim 1, wherein transmission through the fare gate is allowed when the gate paddle rotates, and transmission through the fare gate is blocked when rotation of the gate paddle is stopped.

3. The transmission system with a protection device to enable damage control at a fare gate of claim 1, wherein the gate paddle of a plurality of gate paddles is connected to the paddle shaft to allow transmission at the fare gate based on rotation of the paddle shaft.

4. The transmission system with a protection device to enable damage control at a fare gate of claim 1, wherein the protection device is activated when applied torque at the paddle shaft reaches the preset threshold.

5. The transmission system with a protection device to enable damage control at a fare gate of claim 1, wherein the preset threshold refers to an amount of torque that is allowed at the fare gate and the preset threshold is based on an amount of force applied on a plurality of gate paddles.

6. The transmission system with a protection device to enable damage control at a fare gate of claim 1, wherein the conical clutch is mounted between the paddle shaft and a spur gear to limit torque transmission.

7. The transmission system with a protection device to enable damage control at a fare gate of claim 1, wherein the conical clutch is operable independent of position of a spur gear.

8. A transmission method with a protection device to enable damage control at a fare gate, the transmission method comprises:
rotating, via a motor, a paddle shaft to drive a gate paddle;
allowing transmission through the fare gate by operating the gate paddle; and
providing mechanical protection using the protection device when an abusive load is applied at the fare gate, wherein the protection device comprises:
a conical clutch to limit torque transmission at the fare gate, wherein the conical clutch is operable to:
slip when torque applied to the paddle shaft reaches a preset threshold;
disconnect the motor from a power supply; and
stop rotation of the paddle shaft of the gate paddle.

9. The transmission method with a protection device to enable damage control at a fare gate of claim 8, wherein transmission through the fare gate is allowed when the gate paddle rotates, and transmission through the fare gate is blocked when rotation of the gate paddle is stopped.

10. The transmission method with a protection device to enable damage control at a fare gate of claim 8, wherein the gate paddle of a plurality of gate paddles is connected to the paddle shaft to allow transmission at the fare gate based on rotation of the paddle shaft.

11. The transmission method with a protection device to enable damage control at a fare gate of claim 8, wherein the protection device is activated when applied torque at the paddle shaft reaches the preset threshold.

12. The transmission method with a protection device to enable damage control at a fare gate of claim 8, wherein the preset threshold refers to an amount of torque that is allowed at the fare gate and the preset threshold is based on an amount of force applied on a plurality of gate paddles.

13. The transmission method with a protection device to enable damage control at a fare gate of claim 8, wherein the conical clutch is mounted between the paddle shaft and a spur gear to limit torque transmission.

14. The transmission method with a protection device to enable damage control at a fare gate of claim 8, wherein the conical clutch is operable independent of position of a spur gear.

15. A transmission device with a protection mechanism to enable damage control at a fare gate, the transmission device comprises:
a motor that rotates a paddle shaft to drive a gate paddle;
the gate paddle operable to allow transmission through the fare gate; and
the protection mechanism to provide mechanical protection when an abusive load is applied at the fare gate, wherein the protection mechanism comprises:
a conical clutch to limit torque transmission at the fare gate, wherein the conical clutch is operable to:
slip when torque applied to the paddle shaft reaches a preset threshold;
disconnect the motor from a power supply; and
stop rotation of the paddle shaft of the gate paddle.

16. The transmission device with a protection mechanism to enable damage control at a fare gate of claim 15, wherein transmission through the fare gate is allowed when the gate paddle rotates, and transmission through the fare gate is blocked when rotation of the gate paddle is stopped.

17. The transmission device with a protection mechanism to enable damage control at a fare gate of claim 15, wherein the gate paddle of a plurality of gate paddles is connected to the paddle shaft to allow transmission at the fare gate based on rotation of the paddle shaft.

18. The transmission device with a protection mechanism to enable damage control at a fare gate of claim 15, wherein the protection mechanism is activated when applied torque at the paddle shaft reaches the preset threshold.

19. The transmission device with a protection mechanism to enable damage control at a fare gate of claim 15, wherein the preset threshold refers to an amount of torque that is allowed at the fare gate and the preset threshold is based on an amount of force applied on a plurality of gate paddles.

20. The transmission device with a protection mechanism to enable damage control at a fare gate of claim 15, wherein the conical clutch is mounted between the paddle shaft and a spur gear to limit torque transmission.
